(19) United States
(12) Patent Application Publication
(10) Pub. No.: US 2023/0249113 A1
(43) Pub. Date: Aug. 10, 2023

(54) DUST COLLECTING FILTER AND METHOD FOR MANUFACTURING DUST COLLECTING FILTER

(71) Applicant: LG ELECTRONICS INC., Seoul (KR)

(72) Inventors: Jungryun LEE, Seoul (KR); Seungjae BAECK, Seoul (KR); Okchun HYUN, Seoul (KR); Hyoseok LEE, Seoul (KR); Minjae PARK, Seoul (KR)

(21) Appl. No.: 18/014,601

(22) PCT Filed: Jul. 8, 2021
(86) PCT No.: PCT/KR2021/008755

§ 371 Date: Jan. 5, 2023

(30) Foreign Application Priority Data
Jul. 10, 2020 (KR) 10-2020-0085475

(51) Int. Cl. B01D 46/00; B01D 46/52; B03C 3/45

(52) U.S. Cl. CPC B01D 46/0032; B01D 46/0001; B01D 46/521; B03C 3/45

(57) ABSTRACT

The present invention relates to a dust collecting filter and a method for manufacturing a dust collecting filter. The dust collecting filter of the present invention may include: a first filter medium that is bent into a corrugated shape and forms a plurality of bent portions; a plurality of first electrodes disposed on one surface of the first filter medium along the corrugated shape of the first filter medium and to which a high voltage is applied; and a plurality of second electrodes disposed along the corrugated shape of the first filter medium so as to be spaced apart from each other between the plurality of first electrodes and are grounded.

### TECHNICAL FIELD

The present disclosure relates to a dust collecting filter and method for a manufacturing dust collecting filter. More specifically, The present disclosure relates to the dust collecting filter and the manufacturing dust collecting filter that increasing the area where the electric field is activated in the direction of air flow, decreasing the pressure loss, and increasing the efficiency of collecting foreign substances, through the pattern and arrangement of the electrodes.

### BACKGROUND ART

In general, a dust collecting filter is a device that is attached to an air conditioner such as an air purifier, a cooler or a heater, and collects foreign substances such as dust contained in the air.

A prior art, Korean Patent Registration No. 10-1231574 discloses a dust collecting filter in which porous electrodes are formed on both sides of a dielectric filter medium and a voltage of a certain magnitude is applied between the porous electrodes to electrically polarize the dielectric filter medium and activate it electrostatically.

However, in the prior art, since the electric field is activated only inside the dielectric filter medium, there is a limit to the area for collecting foreign substances in the air through electrostatic force. In addition, since the electrodes are formed on both sides of the dielectric filter medium and are formed of porous electrodes, there is a problem in that the area blocking the transmission area of the filter medium is large and the pressure loss increases.

### DISCLOSURE

### Technical Problem

It is an object of the present disclosure to solve the above and other problems.

It is another object of the present disclosure to increase an area in which an electric field is activated, thereby increasing an area in which foreign substances in the air are collected.

It is another object of the present disclosure to reduce the pressure loss of the filter.

It is another object of the present disclosure to prevent energization due to contact between electrodes while disposing electrodes on a filter medium without insulating coating.

It is another object of the present disclosure to increase the efficiency of collecting foreign substances by inducing the formation of a complex electric field between electrodes.

It is another object of the present disclosure to provide a dust collecting filter whose manufacturing process may be simplified.

The problems of the present invention are not limited to the problems mentioned above, and other problems not mentioned will be clearly understood by those skilled in the art from the following description.

### Technical Solution

In accordance with an aspect of the present disclosures for accomplishing the above and other objects, there may be provided a dust collecting filter including: a first filter medium that is bent into a corrugated shape and forms a plurality of bent portions; a plurality of first electrodes disposed on one surface of the first filter medium along the corrugated shape of the first filter medium and to which a high voltage is applied; and a plurality of second electrodes disposed along the corrugated shape of the first filter medium so as to be spaced apart from each other between the plurality of first electrodes and are grounded. Accordingly, the filtering area of the filter is increased due to the corrugated shape of the filter medium, and the area where the electric field due to the electrode is activated may be increased. More specifically, the first electrode and the second electrode may form an electric field inside the first filter medium and upstream side and downstream side of the first filter medium, and may induce polarization inside the first filter medium. Therefore, the foreign substances collection efficiency may be increased. In addition, since the first electrode and the second electrode are formed only on one side of the filter medium and the electrodes are spaced apart from each other, an area blocking the transmission area of the filter medium may be reduced and pressure loss may be reduced.

the plurality of first electrodes and the plurality of second electrodes may be disposed parallel to each other. Accordingly, an electric field may be uniformly formed between the plurality of first electrodes and second electrodes.

The plurality of first electrodes and second electrodes may be arranged in a direction parallel to a first direction in which a plurality of corrugations of the first filter medium are arranged. Accordingly, it is possible to prevent a phenomenon in which energization is generated due to contact between the first electrode and the second electrode due to bending of the filter medium.

The plurality of first electrodes and second electrodes may be bent in a second direction crossing the first direction in which the plurality of corrugations of the first filter medium are formed and forms a pattern having a plurality of valleys and crests. By forming the pattern, the area where the electric field is activated may be increased. More specifically, the first electrode may be induced to form an electric field with a plurality of second electrodes, and the second electrode may be induced to form an electric field with a plurality of first electrodes. The electrode pattern may be formed as follows.

The first filter medium may include a first flat portions and a second flat portions formed between each of the plurality of bent portions and arranged alternately with each other; the first electrode and the second electrode disposed on the first flat portions may include a portion facing between the first electrode and the second electrode disposed on the second flat portions; and the first electrode and the second electrode disposed on the second flat portions may include a portion facing between the first electrode and the second electrode disposed on the flat portions.

With respect to the pattern of the first electrode and the second electrode, one cycle in which the valleys and crests are repeated may be defined as a pattern unit, and wherein the first filter medium may be bent at least once to form at least one bent portion within the pattern unit.

A first imaginary line L1 passing through a plurality of crests formed by the first electrode, a second imaginary line L2 passing through a plurality of valleys formed by the first electrode, a third imaginary line L3 passing through a plurality of crests formed by the second electrode and a fourth imaginary line L4 passing through a plurality of valleys formed by the second electrode may be defined, wherein the first imaginary line and the fourth imaginary line may be spaced apart from each other, and the second imaginary line and the third imaginary line may be spaced apart from each other.

A distance between the first electrode and the second electrode may be greater than a width of each of the first electrode and the second electrode.

The dust collecting filter may further include a second filter medium disposed on at least one side of an upstream side and a downstream side of the first filter medium. Accordingly, since the second filter medium filters foreign substances in the air once more, the electric field due to the first electrode and the second electrode is activated inside the second filter medium, and the second filter medium may be polarized as like the first filter medium, there is an advantage of increasing the dust collection efficiency.

A pores of the first filter medium are wider than a pores of the second filter medium. Since the second filter medium, which has narrower pores than the pores of the first filter medium, is disposed on at least one of the upstream side and downstream side of the first filter medium to perform filtering once more, the pores of the first filter medium may be focused on reducing the pressure loss and increasing the filtering area by being formed wide.

The dust collecting filter may further include an ion generating device disposed upstream of the first filter medium and generating ions by applying a high voltage. Therefore, the foreign substances may be ionized before passing through the first filter medium, and thus the efficiency of the dust collecting filter to collect foreign substances through the electric field may be increased.

In accordance with an aspect of the present disclosures for accomplishing the above and other objects, there may be provided a method for manufacturing a dust collecting filter including: a coating step of forming a plurality of electrodes spaced apart from each other by coating a conductive material on one surface of a filter medium along the longitudinal direction of the filter medium; and an electrode forming step of forming a first electrode to which a high voltage is applied and a second electrode to be grounded, by alternately connecting a power source to the plurality of electrodes. Therefore, the filter manufacturing process may be simplified. In addition, since the first electrode and the second electrode form an electric field to the inside and outside of the filter medium while inducing polarization inside the filter medium, thereby increasing the efficiency of collecting foreign substances.

The method for manufacturing a dust collecting filter may further include a corrugation forming step of forming a plurality of bent portions arranged in the longitudinal direction of the filter medium by bending the filter medium into a corrugated shape after the coating step. Accordingly, as the filtering area of the filter increases due to the corrugated shape of the filter medium, the area where the electric field due to the electrode is activated may be increased. More specifically, the first electrode and the second electrode may form an electric field inside the first filter medium and upstream side and downstream side of the first filter medium, and may induce polarization inside the first filter medium. Therefore, the foreign substances collection efficiency may be increased.

Wherein the coating step, a conductive material may be coated so that the plurality of electrodes are arranged in parallel with each other. Therefore, it is possible to prevent the first electrode and the second electrode from contacting each other to generate energization.

Wherein the coating step, a conductive material may be coated so that the plurality of electrodes are bent in a direction crossing the longitudinal direction of the filter medium to form a plurality of valleys and crests. By patterning the first electrode and the second electrode and then bending the filter medium, an area where the electric field is activated may increase.

One cycle in which the valleys and crests are repeated may be defined as a pattern unit, and wherein the corrugation forming step may comprise at least one bent portion within the pattern unit.

Details of other embodiments are included in the detailed description and drawings.

### Advantageous Effects

According to the dust collecting filter of the present invention, one or more of the following effects are provided.

First, the filtering area of the filter is increased due to the corrugated shape of the filter medium, and through the arrangement of electrodes, an electric field is activated to the inside and outside of the filter medium. Accordingly, there is an advantage in that the efficiency of collecting foreign substances in the air is increased.

Second, the electrodes are formed only on one side of the filter medium, and the electrodes are spaced apart from each other, thereby reducing the area blocking the transmission area of the filter medium and reducing the pressure loss.

Third, even if the filter medium is bent into a corrugated shape, the first electrode and the second electrode are arranged so as not to contact each other, thereby preventing energization due to contact between the electrodes.

Fourth, after the electrode is patterned on the filter medium, the filter medium is bent to form corrugated to induce the formation of a complex electric field between the electrodes, thereby increasing the efficiency of collecting foreign substances in the air.

Fifth, since electrodes are coated on the filter medium in the longitudinal direction of the filter medium and then the high voltage electrode and the ground electrode are alternately connected, there is also an advantage in that a filter with good dust collection efficiency can be manufactured with a simple manufacturing process.

The effects of the present invention are not limited to the effects mentioned above, and other effects not mentioned will be clearly understood by those skilled in the art from the description of the claims.

### DESCRIPTION OF DRAWINGS

FIG. 1 is a cross-sectional view showing an air conditioner in which a dust collecting filter is installed according to an embodiment of the present invention.

FIGS. 2 and 3 are perspective views showing a dust collecting filter according to a first embodiment of the present invention. Specifically, FIG. 2 shows a state before bending the dust collecting filter into a corrugated shape, and FIG. 3 shows that the dust collecting filter of FIG. 2 is bent along imaginary bending lines b1 and b2 to form a corrugated shape.

FIG. 4 is a diagram showing that a voltage electrode and a ground electrode are connected to a dust collecting filter according to a first embodiment of the present invention.

FIG. 5 is a perspective view showing a filter assembly in which a dust collecting filter according to a first embodiment of the present invention is accommodated in a filter housing.

FIG. 6 is a plan view of the filter assembly shown in FIG. 5 viewed from above.

FIG. 7 is a cross-sectional view of the filter assembly shown in FIG. 5 taken along line I-I′.

FIG. 8 is a cross-sectional view of the filter assembly shown in FIG. 5 taken along line II-II′.

FIG. 9 is a diagram showing a phenomenon in which an electric field is formed and polarization occurs inside and outside the dust collecting filter by enlarging the X region of FIG. 8.

FIG. 10 is a perspective view showing a state before bending the dust collecting filter according to the second embodiment of the present invention into a corrugated shape.

FIG. 11 shows a corrugated shape formed by bending the dust collecting filter of FIG. 10 along imaginary bending lines b1 and b2.

FIG. 12 is an enlarged plan view of a part of the dust collecting filter of FIG. 10 viewed from above.

FIG. 13 is a cross-sectional view of a filter assembly in which a dust collecting filter according to a second embodiment of the present invention is accommodated in a filter housing cut away from the same portion as FIG. 8.

FIG. 14 is a top view of a filter assembly in which a dust collecting filter is accommodated in a filter housing according to a second embodiment of the present invention viewed from the same direction as FIG. 6.

FIG. 15 is a diagram illustrating a phenomenon in which an electric field is activated in a dust collecting filter by enlarging a region Y of FIG. 14.

FIG. 16 is a plan view showing an ion generating device disposed on one side of a filter assembly according to an embodiment of the present invention.

FIG. 17 is a flowchart of a method of manufacturing a dust collecting filter according to an embodiment of the present invention.

### BEST MODE

Advantages and features of the present invention, and methods of achieving them, will become clear with reference to the embodiments described below in detail in conjunction with the accompanying drawings. However, the present invention is not limited to the embodiments disclosed below and may be implemented in various different forms, only the present embodiments make the disclosure of the present invention complete, and it is provided to completely inform the skilled in the art the scope of the present invention, and the present invention is only defined by the scope of the claims. same reference numbers designate same elements throughout the specification.

The spatially relative terms “below”, “beneath”, “lower”, “above”, “upper”, etc. can be used to easily describe components and their correlations with other components. Spatially relative terms should be understood as encompassing different directions of elements in use or operation in addition to the directions shown in the drawings. For example, if a component shown in the drawing is inverted, a component described as “below” or “beneath” another component can be placed “above” the other component. Thus, the exemplary term “below” may include directions of both below and above. Elements may be positioned facing other directions, and thus spatially relative terms may be interpreted according to orientation.

Terminology used herein is for describing the embodiments and is not intended to limit the present invention. In this specification, singular forms also include plural forms unless specifically stated otherwise in a phrase. As used herein, “comprises” and/or “comprising” do not exclude the presence or addition of one or more other components, steps and/or operations other than the stated components, steps and/or operations.

Unless otherwise defined, all terms (including technical and scientific terms) used in this specification may be used in a meaning commonly understood by those of ordinary skill in the art to which the present invention belongs. In addition, terms defined in commonly used dictionaries are not interpreted ideally or excessively unless explicitly specifically defined.

In the drawings, the thickness or size of each component is exaggerated, omitted, or schematically illustrated for convenience and clarity of explanation. Also, the size and area of each component do not entirely reflect the actual size or area.

Hereinafter, with reference to the accompanying drawings, a preferred embodiment of the present invention will be described.

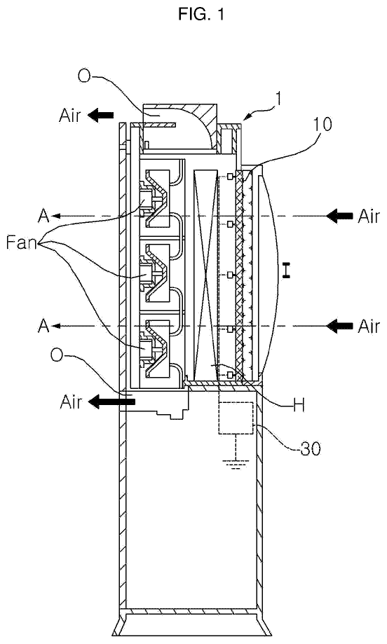

Referring to FIG. 1, in an air conditioner 1 according to an embodiment of the present invention, a suction port I, a fan, and an outlet port O may be sequentially disposed along an air flow direction A. A dust collecting filter 10 and a heat exchanger H may be disposed between the suction port I and the discharge port O.

When the fan is operated, the air introduced through the inlet I may be heat-exchanged in the heat exchanger H and discharged through the discharge port O. At this time, the air introduced through the suction port I passes through the dust collecting filter 10 before being discharged through the discharge port O, and foreign substances in the air may be filtered.

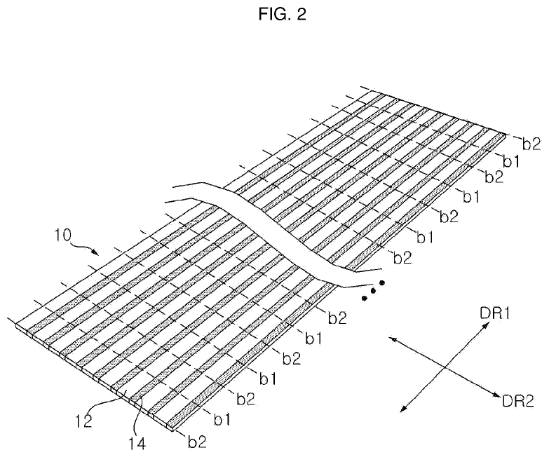

The air conditioner 1 including the dust collecting filter 10 may include a filter housing 20 (see FIG. 2) in which the dust collecting filter 10 is disposed. The filter housing 20 may be installed to be detachable from the air conditioner 1 in a state in which the power of the air conditioner 1 is turned off.

The air conditioner 1 may include a power source 30 that applies a high voltage. The power source 30 may be connected to a controller (not shown), connected to one electrode of the dust collecting filter 10 to provide power, and connected to the other electrode to provide ground. When the fan operates, the power source 30 for applying a high voltage to the dust collecting filter 10 can be turned on, and the dust collecting filter 10 can collect foreign substances in the air flowing by the fan.

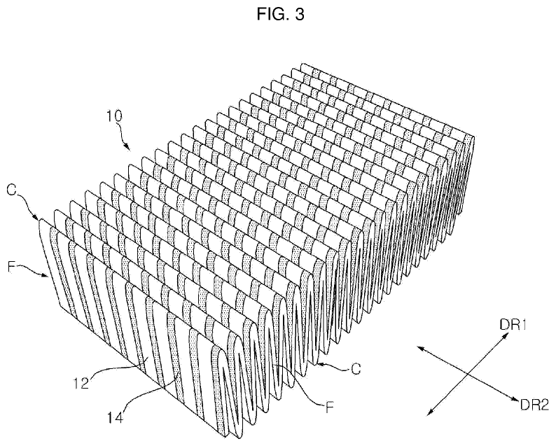

FIG. 2 shows an embodiment of the shape before bending the dust collecting filter 10 according to the first embodiment of the present invention into a corrugated shape, and FIG. 3 shows an embodiment of the shape after bending the dust collecting filter 10 into a corrugated shape. At this time, a direction in which plurality of corrugations of the first filter medium 12 progress or a direction in which plurality of corrugations are formed or arranged may be defined as a first direction DR1. The first direction DR1 may be a longitudinal direction of the first filter medium 12. In addition, a direction crossing the corrugation progression direction (first direction) may be defined as a second direction DR2.

Hereinafter, the dust collecting filter 10 according to the first embodiment of the present invention will be described with reference to FIGS. 2 and 3.

Referring to FIG. 2, the dust collecting filter 10 according to the first embodiment of the present invention may include a first filter medium 12 for collecting foreign substances in the air, and a plurality of electrodes 14 disposed on one surface of the first filter medium 12.

The plurality of electrodes 14 may be formed long in the longitudinal direction of the first filter medium 12, that is, in the first direction DR1, and coated on one surface of the first filter medium 12. That the plurality of electrodes 14 are formed long in the first direction DR1 may include meanings of that they are formed long in a direction parallel to the first direction DR1, and that the plurality of electrodes 14 are formed long in a direction inclined with the first direction DR1 along the first direction DR1.

The plurality of electrodes 14 may be spaced apart from each other in the second direction DR2. Also, the plurality of electrodes 14 may be disposed parallel to each other.

Referring to FIG. 3, the first filter medium 12 may be bent into a corrugated shape and may include a plurality of bent portions C. Accordingly, the filtering area through which the air passes through the first filter medium 12 is increased, and dust collection efficiency can be improved. In addition, since the dust collecting filter 10 is manufactured by coating a plurality of electrodes 14 on only one side of the first filter medium 12 for a long time and then bending the first filter medium 12, the manufacturing process can be simplified and simplified.

More specifically, the first filter medium 12 coated with the plurality of electrodes 14 may be bent along a plurality of imaginary bending lines b1 and b2 shown in FIG. 2 to form a corrugated shape as shown in FIG. 3. In this case, the plurality of bending lines b1 and b2 may be formed long in a direction parallel to the second direction DR2.

When the first filter medium 12 is bent along the plurality of bending lines b1 and b2 to form a corrugated shape as shown in FIG. 3, the bent portion C may be formed long along the second direction DR2. Accordingly, the corrugations of the first filter medium 12 may progress or be arranged along the first direction DR1. In addition, the first filter medium 12 may be provided with a flat portion F having a relatively flat shape between each of the plurality of bent portions C.

The bent part C formed on the part bent by the first bending line b1 may form a crest, and the bent part C formed on the part bent by the second bending line b2 may form a valley.

The plurality of electrodes 14 may be disposed spaced apart from each other on one surface of the first filter medium 12 along the corrugated shape of the first filter medium 12. The plurality of electrodes 14 may be formed long along the corrugated shape of the first filter medium 12 in the first direction DR1 and may be arranged spaced apart from each other in the second direction DR2.

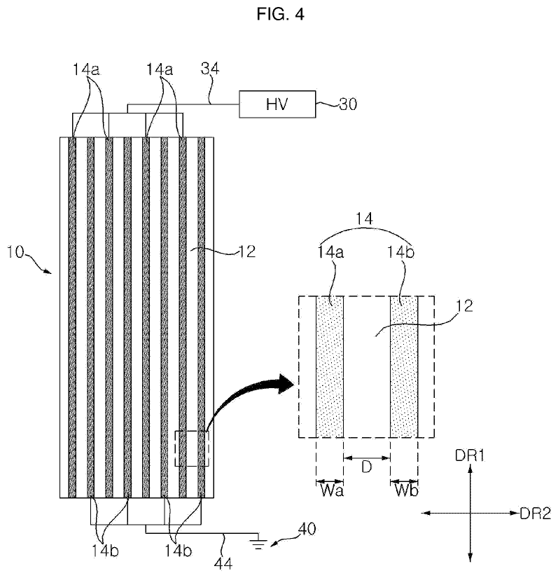

Hereinafter, referring to FIG. 4, the plurality of electrodes 14 may include a plurality of first electrodes 14a and a plurality of second electrodes 14b spaced apart in the second direction DR2 and arranged alternately with each other.

The plurality of first electrodes 14a and the plurality of second electrodes 14b may be disposed long in the longitudinal direction (first direction) DR1 of the first filter medium 12. At this time, when the first filter medium 12 is bent to form a corrugated shape as shown in FIG. 3, the plurality of first electrodes 14a and the plurality of second electrodes 14b may be disposed on one side of the filter medium along the corrugated shape of the first filter medium 12.

A plurality of first electrodes 14a may be disposed on one surface of the first filter medium 12, and a high voltage may be applied. The first electrode 14a may be electrically connected to the power source 30 through the voltage line 34 to receive a high voltage.

A plurality of second electrodes 14b may be disposed on one surface of the first filter medium 12 between each of the plurality of first electrodes 14a and may be grounded. The second electrode 14b may be electrically connected to the ground through the ground portion 40 and the ground line 44 to be grounded. In this case, the plurality of first electrodes 14a and the plurality of second electrodes 14b may be spaced apart from each other in the second direction DR2.

When a voltage is applied from the power source 30 to the plurality of first electrodes 14a, an electric field may be formed between the plurality of first electrodes 14a and the plurality of second electrodes 14b, and the electric field may be activated on the upstream side and downstream side of the first filter medium 12. In addition, the first filter medium 12 between the plurality of electrodes 14a and 14b may be polarized. The first filter medium 12 may be a dielectric material. Details about this will be described later.

Meanwhile, when the first filter medium 12 is bent to form wrinkles as shown in FIG. 3, the thickness of the first filter medium 12 at the bent portion C may be considerably reduced. At this time, in the case of a dust collecting filter in which a first electrode and a second electrode are disposed on both sides of the first filter medium 12 to induce polarization of the inside of the filter medium, a problem in which the first electrode and the second electrode contact each other to conduct electricity may occur. Alternatively, when the first filter medium 12 is bent to form corrugation, the first electrode 14a and the second electrode 14b face each other, and conduct electricity may occur due to contact.

Accordingly, in the case of the dust collecting filter 10 according to the first embodiment of the present invention, the plurality of first electrodes 14a and the plurality of second electrodes 14b may be placed parallel to the corrugation progression direction (first direction) DR1. Since the plurality of first electrodes 14a and the plurality of second electrodes 14b are formed only on one surface of the first filter medium 12, are spaced apart from each other in the second direction DR2, and form corrugations which are parallel to the first direction DR1, there is an advantage in preventing energization due to contact between electrodes.

Meanwhile, the width Wa of the first electrode 14a and the width Wb of the second electrode 14b may be the same or similar. The distance D between the first electrode 14a and the second electrode 14b may be greater than the width Wa of the first electrode 14a and the width Wb of the second electrode 14b. accordingly, the plurality of electrodes 14a and 14b do not unnecessarily blocking the transmission area of the first filter medium 12 and therefore, the pressure loss may be reduced.

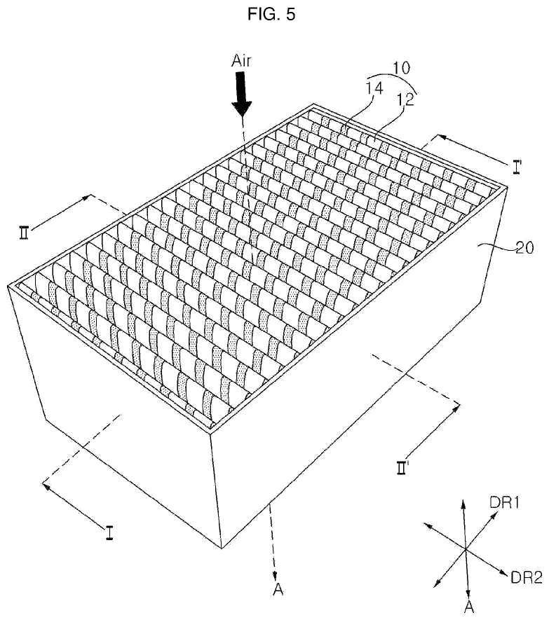

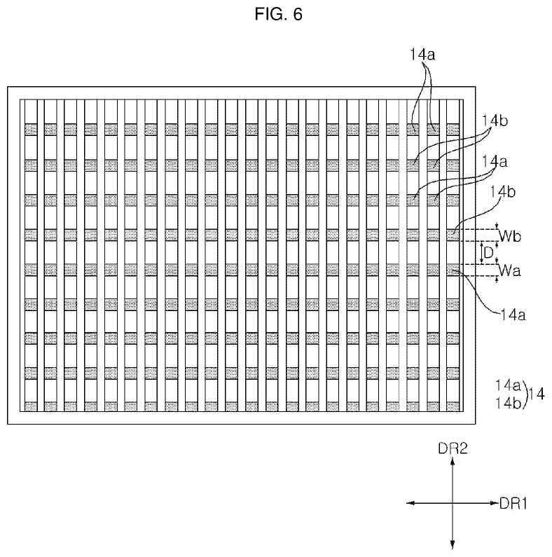

Hereinafter, referring to FIGS. 5 to 7, a filter assembly (not shown) may include a dust collecting filter 10 according to the first embodiment of the present invention and a filter housing 20 accommodating the dust collecting filter.

The dust collecting filter 10 may be disposed such that the plurality of bent portions C face an upstream or downstream of air. In addition, the flat portion F may be disposed long with a slight inclination along the air flow direction A from bent portion at the upstream toward bent portion at the downstream. In this case, the air may flow from the upstream side through the plurality of bent portions C or through the gaps spaced apart between the plurality of bent portions to the downstream side via the flat portion F.

Meanwhile, the filtering area of the first filter medium 12 may be relatively narrow due to the arrangement of the plurality of electrodes 14a and 14b. Accordingly, the dust collecting filter 10 may further include a second filter medium 12a disposed on at least one side of the upstream side or the downstream side of the first filter medium 12 to collect foreign substances in the air. The second filter medium 12a may be accommodated in the filter housing 20 in which the first filter medium 12 is accommodated.

The second filter medium 12a may be polarized due to an electric field formed outside the first filter medium 12 due to the plurality of electrodes 14a and 14b. This will be described later.

The pores of the second filter medium 12a may be narrower than the pores of the first filter medium 12. In other words, the pores of the first filter medium 12 may be wider than the pores of the second filter medium 12a. Since the second filter medium 12a, which has narrower pores than the pores of the first filter medium 12, is disposed on at least one of the upstream side and downstream side of the first filter medium 12 to filter once more, the pores of the first filter medium 12 may be focused on being formed wide so as to increase the filtering area while reduce the pressure loss.

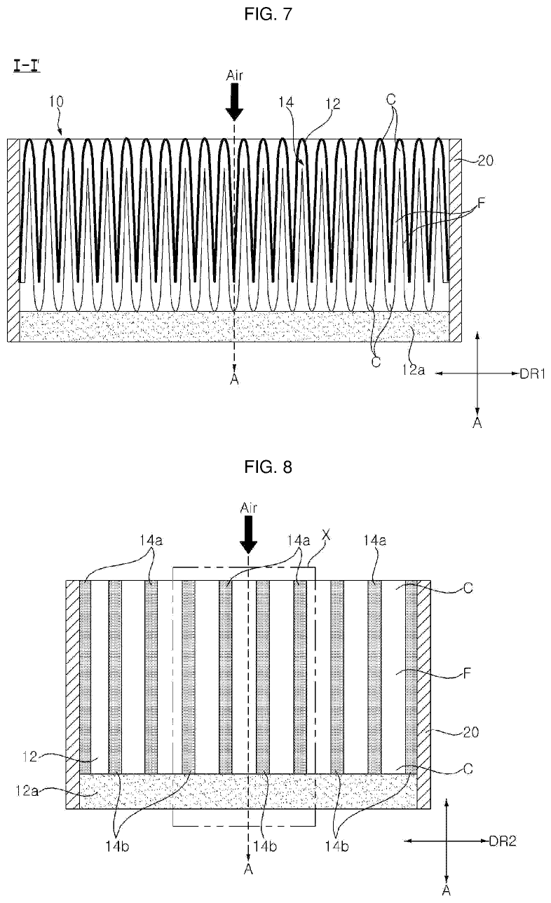

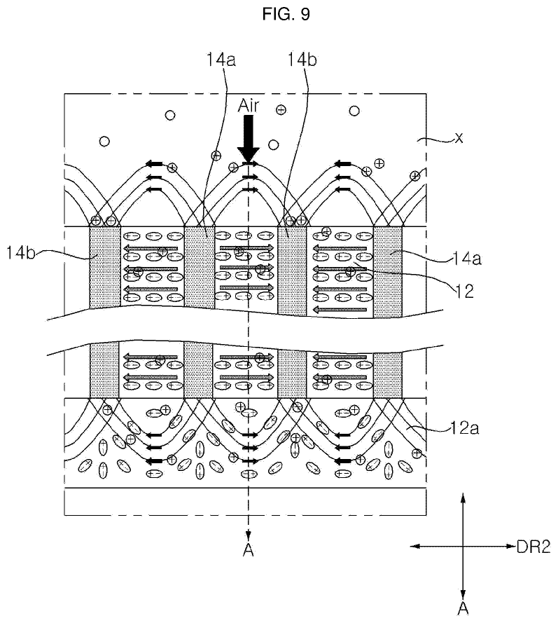

Hereinafter, referring to FIGS. 8 and 9, when a voltage is applied from the power source 30 to the plurality of first electrodes 14a, an electric field may be formed between the plurality of first electrodes 14a and the plurality of second electrodes 14b grounded. Accordingly, the electric field formed by the plurality of electrodes 14a and 14b may be not only activated in the inside of the first filter medium 12, but also activated in the upstream side and downstream side of the first filter medium 12 and in the gaps between the plurality of flat portions F (FIG. 7).

The electric field may induce a dipole moment in particles of the foreign substances in the air to polarize the foreign substances. Accordingly, due to the electrostatic force between the polarized foreign substances and the electrode, the foreign substances may be effectively collected by moving toward one electrode.

In addition, the first filter medium 12 is made of a dielectric material, and when an electric field is activated inside the first filter medium 12 through the plurality of electrodes 14a and 14b, due to the electrostatic force, the foreign subjects and the dielectric fiber of the first filter medium 12 may be electrically polarized. accordingly, a polarization force acts between the polarized foreign subjects and the fibers of the first filter medium 12, so that the foreign subjects can be effectively collected in the first filter medium 12.

Meanwhile, the second filter medium 12a may be disposed on at least one of an upstream side and a downstream side of the first filter medium 12, and the second filter medium 12a may be made of a dielectric material. accordingly, due to an electric field generated outside the first filter medium 12, fibers of the second filter medium 12a may be polarized due to electrostatic force. Therefore, foreign substances can be effectively collected even within the second filter medium 12a.

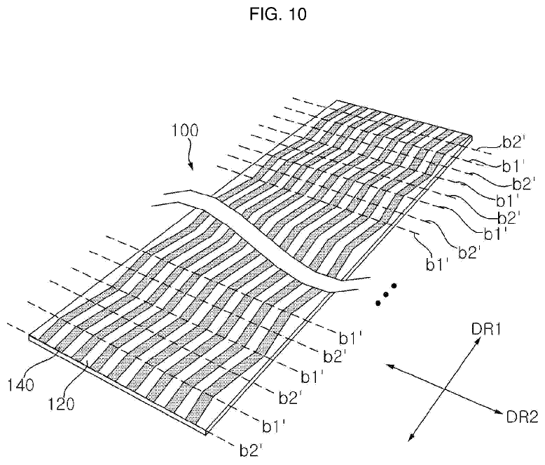

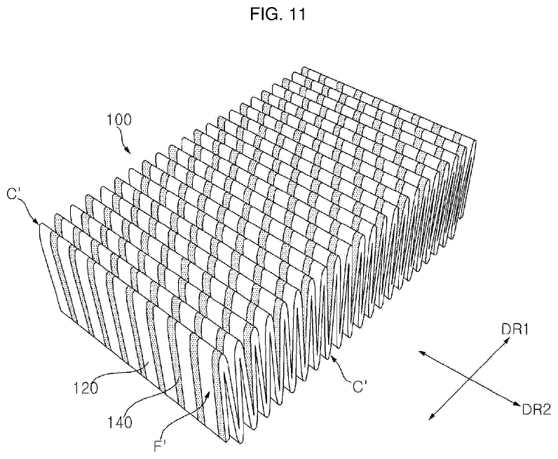

FIG. 10 shows a shape of the dust collecting filter 100 according to the second embodiment of the present invention before being bent into a corrugated shape, and FIG. 11 shows a shape after bending the dust collecting filter 100 into a corrugated shape.

Referring to FIGS. 10 and 11 below, like the dust collecting filter 100 according to the first embodiment of the present invention, the dust collecting filter 100 according to the second embodiment of the present invention may include a first filter medium 120 for collecting foreign substances in the air and a plurality of electrodes 140 disposed on one surface of the first filter medium 120. Hereinafter, the dust collecting filter 100 according to the second embodiment will be mainly described on points different from the dust collecting filter 10 according to the first embodiment, and detailed descriptions of the same points will be omitted.

Referring to FIG. 10, the plurality of electrodes 140 may be disposed parallel to each other in the first direction DR1 on one surface of the filter medium 120. Accordingly, the plurality of electrodes 140 may be bent in a second direction DR2 crossing the first direction DR1 in which the corrugated of the filter material 120 proceed to form a pattern having a plurality of valleys and crests. The pattern may be long in the first direction DR1 in a zigzag shape.

The first filter medium 120 coated with the plurality of electrodes 140 may be bent along a plurality of imaginary bending lines b1′ and b2′ formed in the second direction DR2 to form a corrugated shape as shown in FIG. 11. A bent portion C′ may be formed at the bent lines b1′ and b2′.

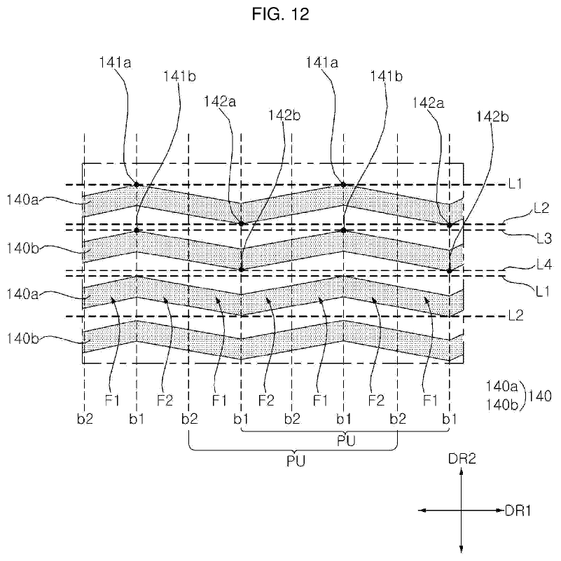

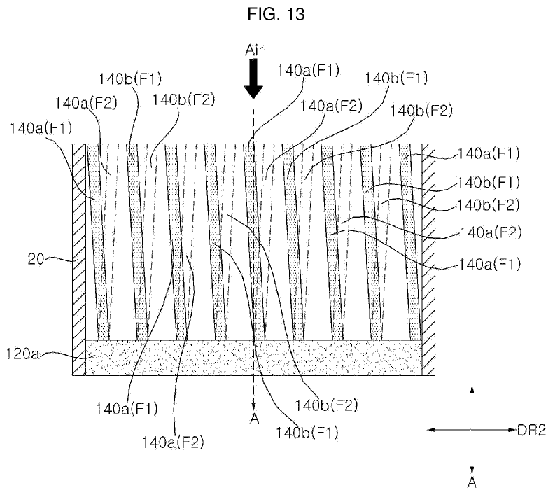

Referring to FIGS. 12 and 13, the first filter medium 120 may include a first flat portion F1 and a second flat portion F2 formed between a plurality of bent portions C′ and arranged alternately with each other. The first flat portion F1 and the second flat portion F2 may be formed between the plurality of bending lines b1′ and b2′ and arranged alternately with each other.

The first electrode 140a and the second electrode 140b disposed on the first flat portion F1 may include a portion facing between the first electrode 140a and the second electrode 140b disposed on the second flat portion F2. In addition, the first electrode 140a and the second electrode 140b disposed on the second flat portion F2 may include a portion facing between the first electrodes 140a and second electrodes 140a disposed on the first flat portion. Accordingly, an electric field may be more activated between the first electrode 140a and the second electrode 140b. A description of this will be given later.

In the pattern of the plurality of electrodes 140, if one cycle that valleys and crests are repeated is defined as a pattern unit PU, the first filter medium 120 is bent at least once within the pattern unit PU, at least one bent portion may be formed in the second direction DR2. That is, the bending lines b1′ and b2′ are formed in the second direction DR2, and regardless of which pattern unit PU is selected in the pattern of the electrode 140, at least one of the plurality of bending lines b1′ and b2 ‘ may exist in the pattern unit PU.

At this time, The bending lines (b1’, b2′) may be arranged so that the first electrode 140a and the second electrode 140b disposed on the first flat portion F1 include portions facing between the first electrode 140a and the second electrode 140b disposed on the second flat portion F2. In addition, The bending lines (b1′, b2′) may be arranged so that the first electrode 140a and the second electrode 140b disposed on the second flat portion F2 include portions facing between the first electrode 140a and the second electrode 140b disposed on the first flat portion F1.

In addition, the bent part C′ may include first bent parts C1′ and second bent parts C2′ that are alternately arranged in the first direction DR1. At this time, for example, the first electrode 140a and the second electrode 140b disposed on the first bent portion C1′ may face between the first electrode 140a and the second electrode 140b disposed on the second bent portion C2′. In addition, the first electrode 140a and the second electrode 140b disposed on the second bent portion C2′ may face between the first electrode 140a and the second electrode 140b disposed on the first bent portion C1′.

On the other hand, a first imaginary line L1 passing through a plurality of crests formed by the first electrode 140a may be defined. A second imaginary line L2 passing through a plurality of valleys formed by the first electrode 140a may be defined. A third imaginary line L3 passing through a plurality of crests formed by the second electrode 140b may be defined. A fourth imaginary line L4 passing through a plurality of valleys formed by the second electrode 140b may be defined.

In this case, the first imaginary line L1 and the fourth imaginary line L4 may be spaced apart from each other, and the second imaginary line L2 and the third imaginary line L3 may be spaced apart from each other. The first to fourth imaginary lines L1, L2, L3, and L4 may be formed parallel to the first direction DR1 and perpendicular to the bending lines b1′ and b2′. Therefore, even if corrugations are formed at the filter medium 120, electricity generated by contact between the first electrode 140a and the second electrode 140b can be prevented.

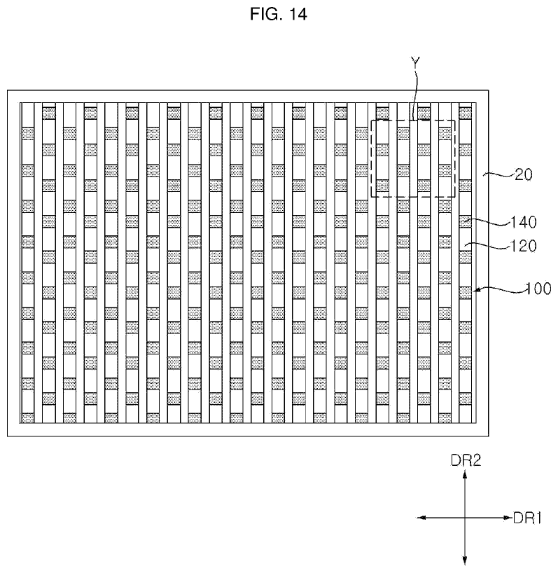

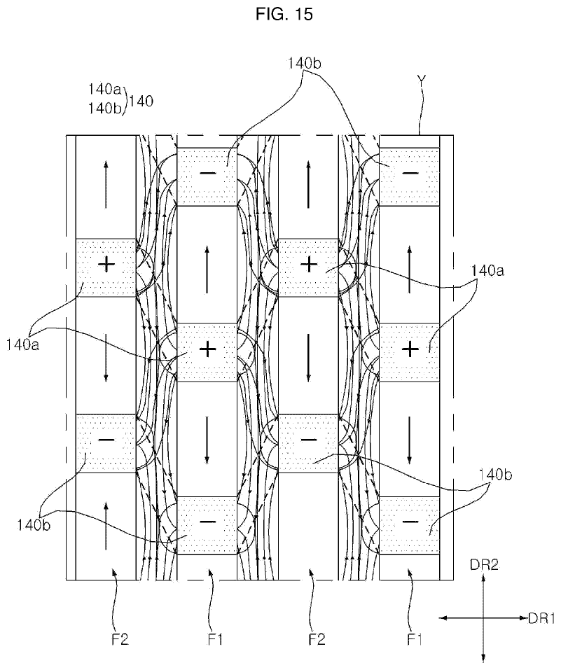

Hereinafter, effects of the dust collecting filter 100 according to the second embodiment of the present invention will be described with reference to FIGS. 14 and 15. For better understanding, a description will be made in comparison with the first embodiment.

In the case of the dust collecting filter 10 of the first embodiment, the plurality of electrodes 14a and 14b may be formed parallel to the first direction DR1. Therefore, in this case, the first electrode 14a formed on the first flat portion F1 may face the first electrode 14a formed on the second flat portion F2.

On the other hand, in the case of the dust collection filter 100 according to the second embodiment of the present invention, the plurality of electrodes 140a and 140b may be bent in the second direction DR2 to form a zigzag pattern having a plurality of valleys and crests. Therefore, compared to the first embodiment, the distance between the first electrode 140a formed on the first flat portion F1 and the second electrode 140b formed on the second flat portion F2 may be narrower.

Since the strength of the electric field is inversely proportional to the square of the distance between the electrodes, the electric field can be more activated between the first flat part F1 and the second flat part F2. In this case, intensity of the electric field is increased than that of the first embodiment. Therefore, since the ability to polarize foreign substances in the air passing through the first flat portion F1 and the second flat portion F2 increases, and dust collection efficiency by electrostatic force may be improved.

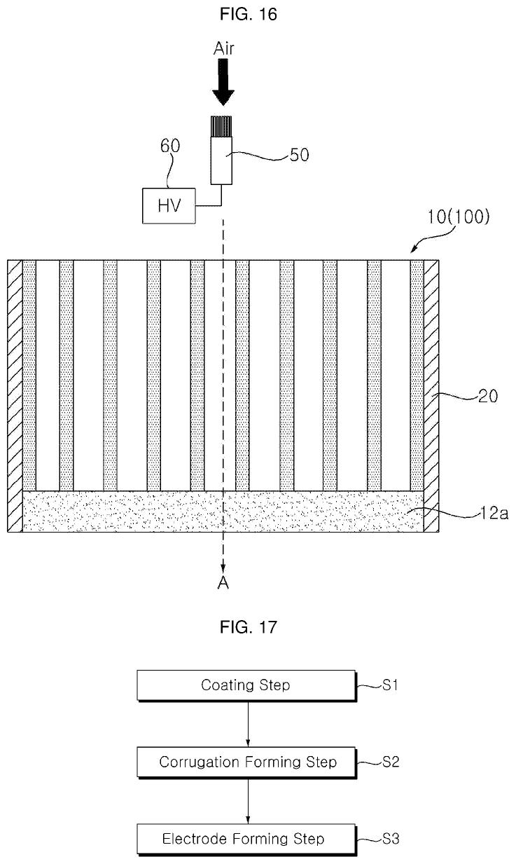

Referring to FIG. 16, an ion generator 50 generating ions may be disposed upstream of the dust collecting filters 10 and 100 according to an embodiment of the present invention. The ion generator 50 may be connected to the power source 60 and receive a high voltage from the power source to generate ions in the air through discharge.

The ion generator 50 may induce the electrostatic force between the ionized foreign matter and the electrode to act by ionizing foreign substances in the air before the air passes through the dust collecting filters 10 and 100.

Referring to FIG. 17, method for a manufacturing dust collecting filter according to an embodiment of the present invention may include at least one of a coating step S1, a corrugation forming step S2, and an electrode forming step S3.

In the coating step S1, a conductive material is coated on one surface of the filter medium 10, 100 along the longitudinal direction (first direction) DR1 of the filter medium, and a plurality of electrodes 14, 140 spaced apart from each other may be formed (see FIG. 2).

For example, the conductive material may be carbon ink. Specifically, a plurality of carbon ink lines spaced apart from each other may be formed by rolling a roll filled with carbon ink on one surface of the filter medium 10.

Method for a manufacturing dust collecting filter according to an embodiment of the present invention may include forming step (S3) of forming a first electrode to which a high voltage is applied 14a and 140a, and the second electrodes 14b and 140b to be grounded, by connecting a power source 30 to the plurality of electrodes 14 and 140 alternately, after the coating step S1. At this time, a voltage line 34 to which a high voltage is applied from the power supply 30 may be connected to the first electrodes 14a and 140a, and a ground line 44 may be connected alternately to the second electrodes 14b and 140b for grounding. (see FIG. 4).

Since the conductive material is coated in the longitudinal direction of the filter medium 12 and then the power source 30 and the ground 40 are alternately connected, the method for a manufacturing dust collecting filter according to an embodiment of the present invention has the advantage of simplifying the manufacturing process.

The method for manufacturing a dust collecting filter according to an embodiment of the present invention may further include a corrugation forming step S2 after the coating step S1. The corrugation forming step S2 may be performed between the coating step S1 and the electrode forming step S3, or may be performed after the electrode forming step S3. In the corrugation forming step S2, the filter media 12 and 120 may be bent into a corrugated shape to form a plurality of bent portions C and C′ arranged in the longitudinal direction (first direction, DR1) of the filter media. (See FIG. 3)

Meanwhile, in the coating step S1, a pattern of the electrodes 14 of the dust collecting filter 10 according to the first embodiment may be formed by coating a conductive material so that the plurality of electrodes 14 are arranged in parallel with each other.

Alternatively, in the coating step S1, a pattern of the electrode 140 of the dust collecting filter 10 according to the second embodiment may be formed by coating a conductive material so that the plurality of electrodes 14 are bent in a direction (second direction, DR2) crossing the corrugation progression direction (first direction, DR1) of the filter medium 120 to form a plurality of valleys and crests (see FIGS. 10 and 11).

At this time, in the corrugation forming step S2, the filter medium 120 may be bent into a corrugated shape to form at least one bent portion C′ in the pattern unit PU (see FIG. 12). That is, as described above, the bending lines b1′ and b2′ are formed in the second direction DR2, and no matter which pattern unit PU is selected in the pattern of the electrode 140, at least one of a plurality of bending lines b1′ and b2′ may be present in the pattern unit PU.

In the above, the preferred embodiment of the present invention has been shown and described, but the present invention is not limited to the specific embodiment described above, various modifications can be made by those skilled in the art without departing from the subject matter of the present invention claimed in the claims, and these modifications should not be understood individually from the technical spirit or perspective of the present invention.

1. A dust collecting filter including:
a first filter medium that is bent into a corrugated shape and forms a plurality of bent portions;
a plurality of first electrodes disposed on one surface of the first filter medium along the corrugated shape of the first filter medium and to which a high voltage is applied; and
a plurality of second electrodes disposed along the corrugated shape of the first filter medium so as to be spaced apart from each other between the plurality of first electrodes and are grounded.

2. The dust collecting filter according to claim 1, wherein the plurality of first electrodes and the plurality of second electrodes are disposed parallel to each other.

3. The dust collecting filter according to claim 2, wherein the plurality of first electrodes and second electrodes are arranged in a direction parallel to a first direction in which a plurality of corrugations of the first filter medium are arranged.

4. The dust collecting filter according to claim 2, wherein the plurality of first electrodes and second electrodes are bent in a second direction crossing the first direction in which the plurality of corrugations of the first filter medium are formed and forms a pattern having a plurality of valleys and crests.

5. The dust collecting filter according to claim 4, wherein the first filter medium includes a first flat portions and a second flat portions formed between each of the plurality of bent portions and arranged alternately with each other;
wherein the first electrode and the second electrode disposed on the first flat portions include a portion facing between the first electrode and the second electrode disposed on the second flat portions; and
wherein the first electrode and the second electrode disposed on the second flat portions include a portion facing between the first electrode and the second electrode disposed on the flat portions.

6. The dust collecting filter according to claim 5, wherein, with respect to the pattern of the first electrode and the second electrode, one cycle in which the valleys and crests are repeated is defined as a pattern unit, and
wherein the first filter medium is bent at least once to form at least one bent portion within the pattern unit.

7. The dust collecting filter according to claim 4, wherein a first imaginary line L1 passing through a plurality of crests formed by the first electrode, a second imaginary line L2 passing through a plurality of valleys formed by the first electrode, a third imaginary line L3 passing through a plurality of crests formed by the second electrode and a fourth imaginary line L4 passing through a plurality of valleys formed by the second electrode are defined,
wherein the first imaginary line and the fourth imaginary line are spaced apart from each other, and the second imaginary line and the third imaginary line are spaced apart from each other.

8. The dust collecting filter according to claim 1, wherein a distance between the first electrode and the second electrode is greater than a width of each of the first electrode and the second electrode.

9. The dust collecting filter according to claim 1, further comprising a second filter medium disposed on at least one side of an upstream side and a downstream side of the first filter medium.

10. The dust collecting filter according to claim 9, wherein a pores of the first filter medium are wider than a pores of the second filter medium.

11. A method for manufacturing a dust collecting filter including:
a coating step of forming a plurality of electrodes spaced apart from each other by coating a conductive material on one surface of a filter medium along the longitudinal direction of the filter medium; and
an electrode forming step of forming a first electrode to which a high voltage is applied and a second electrode to be grounded, by alternately connecting a power source to the plurality of electrodes.

12. The method of manufacturing the dust collecting filter according to claim 11, further comprising a corrugation forming step of forming a plurality of bent portions arranged in the longitudinal direction of the filter medium by bending the filter medium into a corrugated shape after the coating step.

13. The method of manufacturing the dust collecting filter according to claim 12, wherein the coating step, a conductive material is coated so that the plurality of electrodes are arranged in parallel with each other.

14. The method of manufacturing the dust collecting filter according to claim 13, wherein the coating step, a conductive material is coated so that the plurality of electrodes are bent in a direction crossing the longitudinal direction of the filter medium to form a plurality of valleys and crests.

15. The method of manufacturing the dust collecting filter according to claim 14, wherein one cycle in which the valleys and crests are repeated is defined as a pattern unit, and wherein the corrugation forming step comprises at least one bent portion within the pattern unit.
